(19) United States
(12) Patent Application Publication
(10) Pub. No.: US 2007/0182950 A1
(43) Pub. Date: Aug. 9, 2007

(54) Distance measurement device

(76) Inventor: David Arlinsky, Atlit (IL)

Correspondence Address: NATH & ASSOCIATES, 112 South West Street, Alexandria, VA, 22314, US

(21) Appl. No.: 10/592,076

(22) PCT Filed: Mar. 10, 2005
(86) PCT No.: PCT/IL05/00277

§ 371 Date: Sep. 7, 2006

(30) Foreign Application Priority Data
Mar. 13, 2004 (IL) 160859

(51) Int. Cl. G01C 3/08

(52) U.S. Cl. 356/5.01

(57) ABSTRACT

A distance measurement device including a handheld housing with a distance measurement module for transmitting a measurement signal aimed toward a distant object and receiving a measurement signal reflected therefrom for determining the distance measurement thereto, and a head-up display (HUD) for enabling a user to simultaneously view the object and distance related information.

### CROSS-REFERENCE TO RELATED APPLICATIONS

This application is the United States National Stage filing of PCT Application PCT/I12005/000277 having an international filing date of Mar. 10, 2005.

### FIELD OF THE INVENTION

The invention is in the field of distance measurement devices in general and handheld electronic distance measurement devices in particular.

### BACKGROUND OF THE INVENTION

Handheld electronic distance measurement devices have a remote control shaped housing including a distance measurement module for transmitting a measurement signal aimed toward a typically distant object and receiving a measurement signal reflected therefrom for determining the distance measurement thereto, and a display screen for displaying measurement related information including inter alia distance measurements, operation menus and operation screens for operating the device, preferred user settings, say, metric measurements, and the like. Distance measurement devices are commercially available with either an accurate laser distance measurement module employing a laser measurement signal for determining distance measurements up to, say, 50 m, or a less accurate ultrasound distance measurement module employing an ultrasound measurement signal for determining distance measurements up to, say, 30 m. Laser distance measurement devices typically employ the laser measurement signal also for pointing purposes, and are commercially available from inter alia Leica Geosystem AG, CH-9435 Heerbrugg, Switzerland (www.leica-geosystems.com) under the DISTO™ trademark. Ultrasound distance measurement devices typically include a built-in laser pointer for pointing purposes, and are commercially available from inter alia NewellRubbermaid, Huntersville, N.C. 28078-1801, USA (www.strait-line.com) under the STRAIT-LINE® trademark.

Distance measurement devices may be used with various accessories, for example, a tripod for steadying purposes, a clip on bubble vial for providing a visual indication regarding a device's inclination to the horizontal, and the like, for assisting a user to take distance measurements depending on inter alia the number of distance measurements to be taken, the length of time available to take them, their desired accuracy, and the like. For example, a user may take distance measurements writing them down one by one after each distance measurement or take several distance measurements in quick succession for storing in a scroll through memory for later retrieval. Be that as it may, a user assumes either a generally forward looking stance for viewing a distant object or a generally downward looking stance toward the device itself for viewing its control panel, its display screen, and a clip on bubble vial if attached. Repeated head movements between the two stances is time consuming and awkward and can lead to improper use of a distance measurement device to the detriment of a job at hand. Moreover, it often leads to user discomfort and even eyestrain.

### SUMMARY OF THE INVENTION

The present invention is for a novel distance measurement device having a head-up display (HUD) with a HUD display screen for displaying measurement related information for enabling a user viewing a distant object in a generally forward looking stance and holding the device at about eyelevel to simultaneously view a virtual image of the HUD display screen through a HUD flip-up combiner in a flipped-up position. When the HUD flip-up combiner is in its normal stow away position generally flush within the distance measurement device's housing for carrying purposes and certain measuring applications, the distance measurement device of the present invention preferably employs its HUD display screen for displaying measurement related information for viewing by a user in a conventional generally downward looking stance. A distance measurement device may be additionally provided with a fixed main display screen for displaying measurement related information such that a user can view same without having to shut the HUD flip-up combiner. The user also preferably views a virtual image of a visual indication of the inclination of a distance measurement device with respect to the horizontal together with the virtual image of the HUD display screen.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a combined perspective view and schematic block diagram of a distance measurement device including a head-up display (HUD) and an inclination indication device;

FIG. 2 is a perspective view showing a user holding FIG. 1's distance measurement device at about eyelevel for simultaneously viewing a distant object and measurement related information;

FIG. 3 is an optical ray diagram showing a HUD optical arrangement of FIG. 1's distance measurement device;

FIG. 4 is an optical ray diagram showing an alternative HUD optical arrangement of FIG. 1's distance measurement device;

FIG. 5 is an optical ray diagram showing an implementation of FIG. 1's distance measurement device's inclination indication device; and

FIG. 6 is a combined perspective view and block diagram of a distance measurement device including a head-up display (HUD), and a fixed main display screen.

### DETAILED DESCRIPTION OF PREFERRED EMBODIMENTS OF THE INVENTION

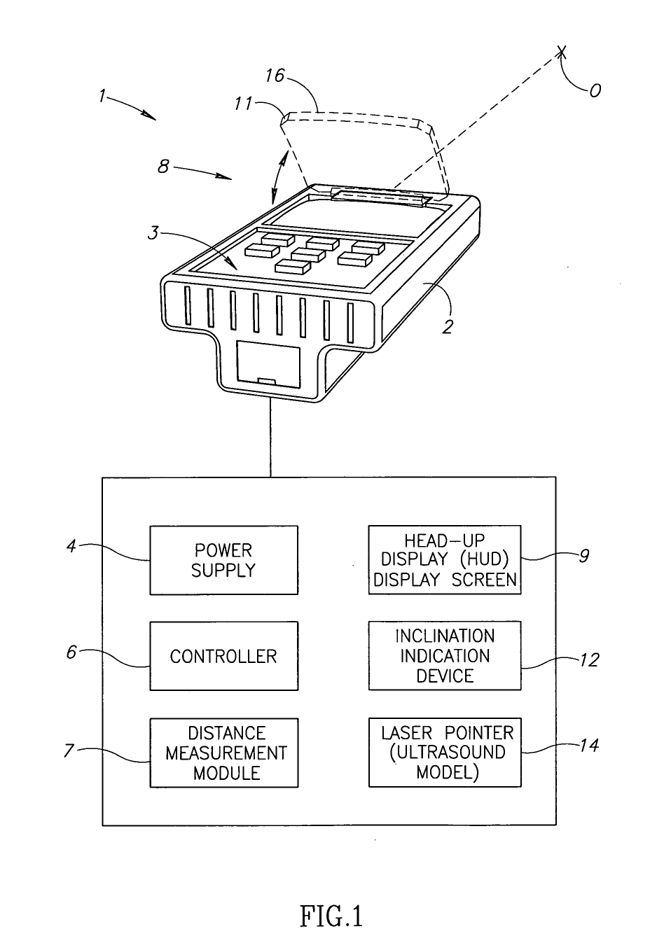

FIG. 1 shows a distance measurement device 1 including a handheld remote control shaped housing 2 with a control panel 3, a power supply 4, a controller 6, a laser or ultrasound distance measurement module 7 for transmitting a measurement signal aimed toward a distant object O and receiving a measurement signal reflected therefrom for determining the distance measurement thereto, and a head-up display (HUD) 8 including a HUD display screen 9 and an arcuate transparent HUD flip-up combiner 11 selectively disposable between a stowed away position (shown in solid lines) generally flush with the housing 2, and a flipped-up position (shown in dashed lines) for intercepting a user's view of the object O when holding the housing 2 at about eyelevel and aiming thereat. Displacement of the HUD flip-up combiner 11 between its stowed away position and its flipped-up position may be implemented using a manually released spring biased mechanism for effecting a pop-up action on depression of a release button. Alternatively, displacement of the HUD flip-up combiner 11 may be effected by electromechanical means.

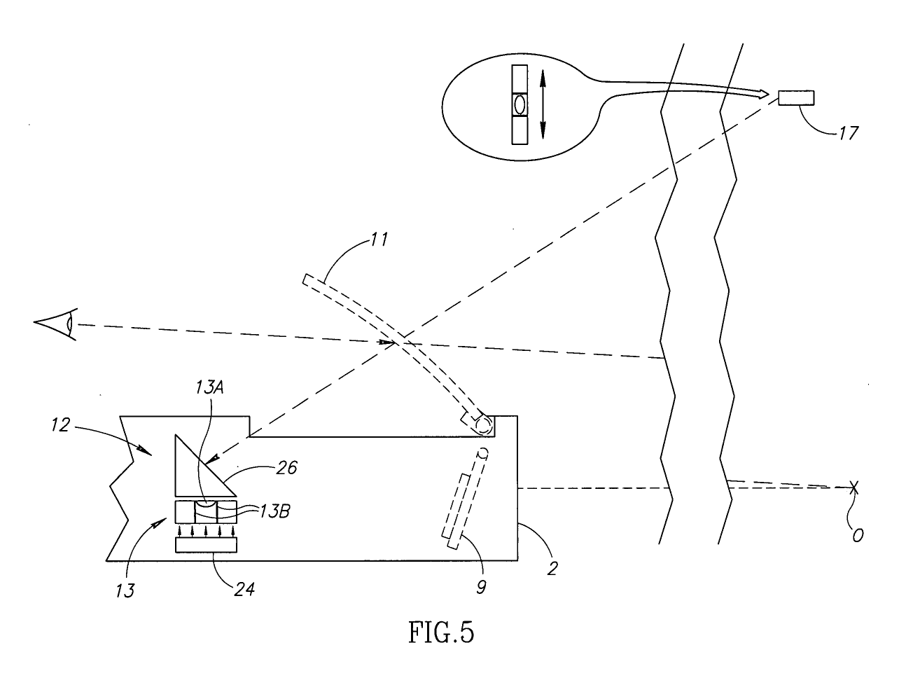

The distance measurement device 1 also includes a built-in inclination indication device 12 responsive to the inclination of the housing 2 with respect to the horizontal for providing a visual indication of same. The inclination indication device 12 is preferably implemented by a bubble vial 13 with an air bubble 13A displaceable between a pair of reference markings 13B (see FIG. 5) but alternatively it may be implemented by an electronic inclinometer. Additionally or alternatively, a horizontal state of the housing 2 may be indicated by an audible tone. The distance measurement device 1 also includes a laser pointer 14 for pointing a laser spot at the object O in the case of an ultrasound distance measurement module 7. The HUD flip-up combiner 11 has a coating 16 for enhancing the naked eye visibility of the laser spot.

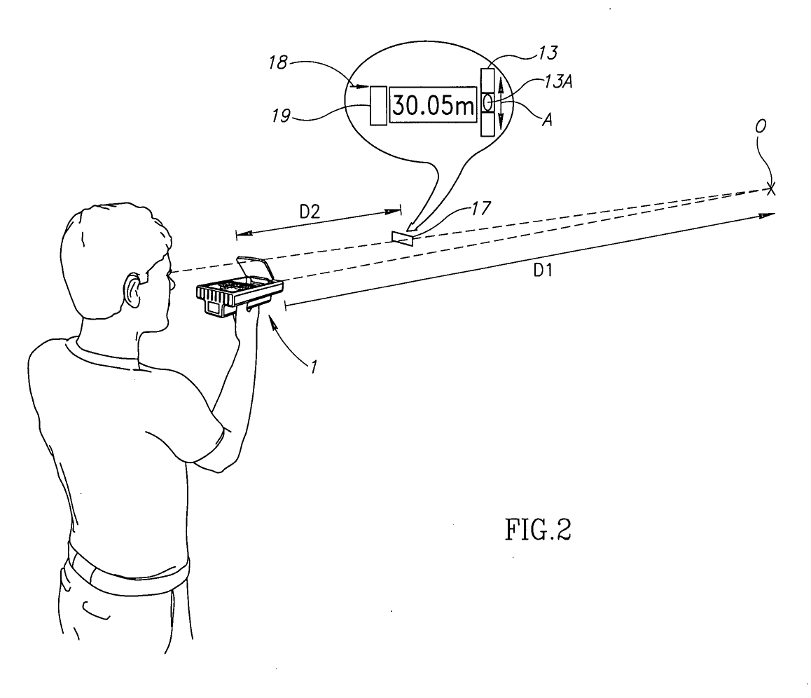

FIG. 2 shows a user simultaneously viewing the object O in a generally forward looking stance at a distance D1 of, say, between 5 m and 50 m, and a virtual image 17 of the HUD display screen 9 and the inclination measurement device's bubble vial 13 at a distance D2 of about 3 m forward of the HUD flip-up combiner 11. In the present instance, the HUD display screen 9 displays the distance measurement D1 of, say, 30.05 m from the housing's leading surface as visually indicated by a pointer icon 18 pointing to the leading line of the rectangular icon 19 representing the housing 2. Also in the present instance, the inclination measurement device's bubble vial 13 shows that the housing 2 is perfectly horizontal. Forward or backward inclination of the housing 2 respect to the horizontal causes up and down displacement of the bubble vial's air bubble 13A denoted by arrow A. The HUD display screen 9 and the bubble vial 13 can appear side by side in the virtual image 17 at the same depth of view or at different depths of view depending on the optical arrangement of the distance measurement device 1.

The distance measurement device 1 also enables a user to view measurement related information shown on the HUD display screen 9 in a conventional generally downward looking stance in addition to his generally forward looking stance. Generally speaking, this involves toggling the HUD display screen 9 between a generally horizontal position in the HUD flip-up combiner's stowed away position and an inclined position in the HUD flip-up combiner's flipped-up position for rendering the virtual image 17 when a user views the object O in his generally forward looking stance. Displacement of the HUD flip-up combiner 11 between its stow away position and its flipped-up position preferably simultaneously automatically effects displacement of the HUD display screen 9 between its generally horizontal position and its inclined position.

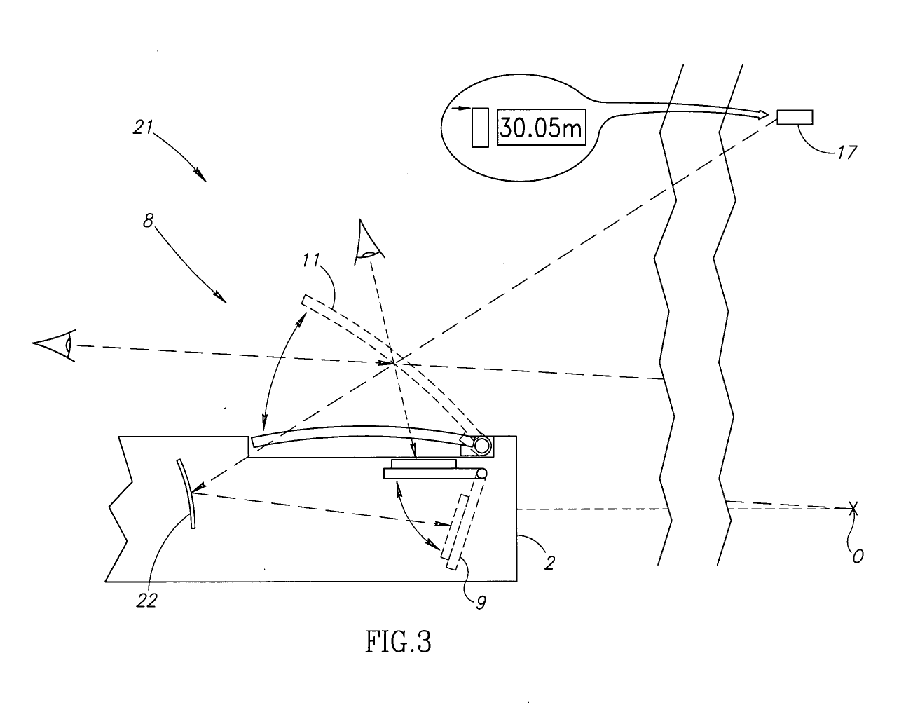

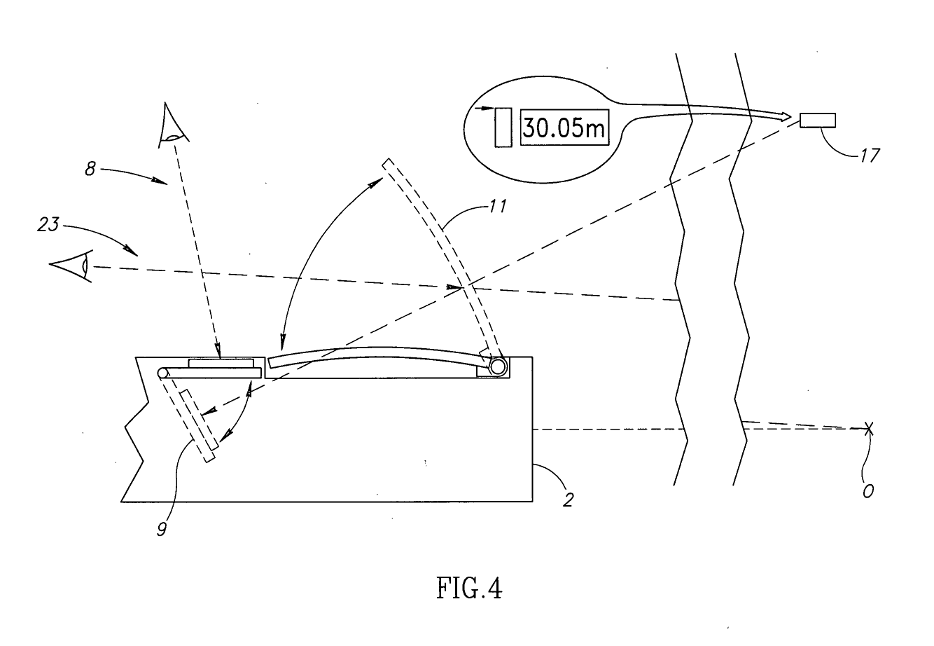

The virtual image 17 of the HUD display screen 9 on viewing the object O through the HUD flip-up combiner 11 may be effected by several HUD optical arrangements. FIG. 3 shows one such HUD optical arrangement 21 including a mirror 22 which enables the HUD display screen 9 to display measurement related information in the same direction irrespective of whether a user is viewing same in his generally forward looking stance or his generally downward looking stance. In this case, the HUD display screen 9 underlies the HUD flip-up combiner 11 in its horizontal position whereby the user views same in his generally downward looking stance through the HUD flip-up combiner 11. FIG. 4 shows another such HUD optical arrangement 23 without an additional optical element but requiring that the measurement display information be inverted when being displaying in the HUD display screen's horizontal position as opposed to its inclined position to ensure that it always appear upright as viewed by a user.

FIG. 5 shows that the inclination indication device 12 includes the bubble vial 13 backlighted by a backlight 24 and viewed via a prism 26. Deployment of the inclination indication device 12 next to the mirror 22 causes the HUD display screen 9 and the bubble vial 13 to appear side by side in the virtual image 17. Against this, deployment of the inclination indication device 12 in front of or behind the mirror 22 causes the HUD display screen 9 and the bubble vial 13 to appear at different depths of view in the virtual image 17. Correspondingly effects can be achieved in FIG. 4's optical arrangement 23.

The use of the distance measurement device 1 for measuring a room's approximate square footage is as follows: A user stands in the middle of the room and holds the housing at about eyelevel with its HUD flip-up combiner in its flipped-up position. The user views one wall in his forward looking stance making sure that the bubble vial indicates that the housing is horizontal and takes a first widthwise distance measurement which he stores in memory. The user then faces the opposing wall and takes a second widthwise distance measurement which he also stores into memory. The user takes two lengthwise distance measurements in the same fashion. The user shuts the HUD flip-up combiner and assumes his generally downward looking stance for operating the device, namely, to calculate the room's width and length, and then its area.

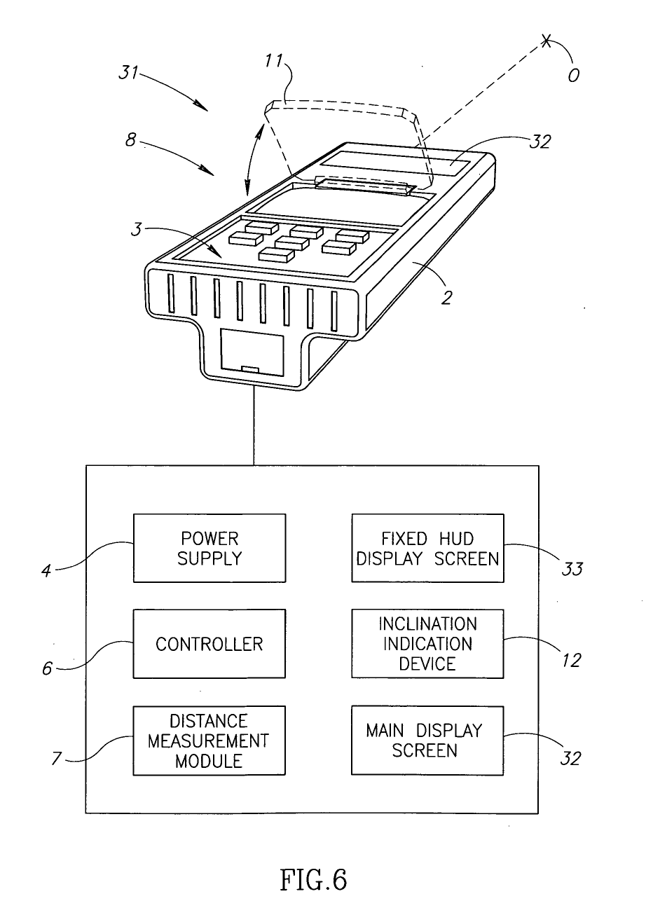

FIG. 6 shows a distance measurement device 31 similar in construction and operation to the distance measurement device 1 but additionally including a fixed main display screen 32 for displaying measurement related information thereby enabling a user to view same without having to shut the HUD flip-up combiner 11. Moreover, the fixed main display screen 32 also simplifies the HUD 8 since it enables the deployment of a fixed HUD display screen 33 as opposed to the displaceable HUD display screen 9.

While the invention has been described with respect to a limited number of embodiments, it will be appreciated that many variations, modifications, and other applications of the invention can be made within the scope of the appended claims.

1. A distance measurement device comprising a handheld housing with a distance measurement module for transmitting a measurement signal aimed toward a distant object and receiving a measurement signal reflected therefrom for determining the distance measurement thereto, and a head-up display (HUD) including i) a HUD display screen for displaying measurement related information, and ii) a HUD flip-up combiner selectively disposable between a stowed away position generally flush with said housing, and a flipped-up position for intercepting a user's view of the object in a generally forward looking stance when holding the device at about eyelevel and aimed at the object for enabling a user to simultaneously view through said HUD flip-up combiner the object and said measurement related information in a virtual image of said HUD display screen.

2. The device according to claim 1 wherein said HUD display screen toggles between a generally horizontal position in said HUD flip-up combiner's stowed away position for viewing by the user in a generally downward looking stance toward said housing, and an inclined position in said HUD flip-up combiner's flipped-up position for rendering said virtual image of said HUD display screen on viewing the object through said HUD flip-up combiner in the user's generally forward looking stance.

3. The device according to claim 2 wherein said HUD display screen substantially underlies said HUD flip-up combiner in its substantially horizontal position whereby the user views said HUD display screen through said HUD flip-up combiner in his generally downward looking stance toward said housing.

4. The device according to claim 1 wherein said housing includes a fixed main display screen for displaying measurement related information for viewing by a user in a generally downward looking stance toward said housing.

5. The device according to claim 1 wherein said housing includes a built-in inclination indication device responsive to said housing's inclination with respect to the horizontal for providing a visual indication of same for viewing by the user at least when viewing the object through said HUD flip-up combiner in its flipped-up position.

6. The device according to claim 5 wherein said inclination indication device includes an illuminated bubble vial.

7. The device according to claim 5 wherein said visual indication has a different depth of view from said virtual image of said HUD display screen as viewed by a user viewing the object through said HUD flip-up combiner in its flipped-up position.

8. The device according to claim 1 wherein said HUD flip-up combiner has a coating for enhancing the naked eye visibility of a laser spot aimed toward the object for pointing purposes.

9. The device according to claim 2 wherein said housing includes a built-in inclination indication device responsive to said housing's inclination with respect to the horizontal for providing a visual indication of same for viewing by the user at least when viewing the object through said HUD flip-up combiner in its flipped-up position.

10. The device according to claim 9 wherein said inclination indication device includes an illuminated bubble vial.

11. The device according to claim 9 wherein said visual indication has a different depth of view from said virtual image of said HUD display screen as viewed by a user viewing the object through said HUD flip-up combiner in its flipped-up position.

12. The device according to claim 9 wherein said HUD flip-up combiner has a coating for enhancing the naked eye visibility of a laser spot aimed toward the object for pointing purposes.

13. The device according to claim 4 wherein said housing includes a built-in inclination indication device responsive to said housing's inclination with respect to the horizontal for providing a visual indication of same for viewing by the user at least when viewing the object through said HUD flip-up combiner in its flipped-up position.

14. The device according to claim 13 wherein said inclination indication device includes an illuminated bubble vial.

15. The device according to claim 13 wherein said visual indication has a different depth of view from said virtual image of said HUD display screen as viewed by a user viewing the object through said HUD flip-up combiner in its flipped-up position.

16. The device according to claim 13 wherein said HUD flip-up combiner has a coating for enhancing the naked eye visibility of a laser spot aimed toward the object for pointing purposes.
